(19) United States
(12) Patent Application Publication
(10) Pub. No.: US 2006/0282537 A1
(43) Pub. Date: Dec. 14, 2006

(54) System and method of responding to a full TCP queue

(75) Inventors: Venkat Venkatsubra, Austin, TX (US); Richard Perry Youngman, Cedar Park, TX (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 11/149,184

(22) Filed: Jun. 9, 2005

(51) Int. Cl. G06F 15/16

(52) U.S. Cl. 709/228

(57) ABSTRACT

A system and method of responding to a full TCP queue. After a server receives a TCP connection request from a client, the server places the request on an embryonic queue of TCP connection requests sorted by the amount of elapsed time since the server has respond to each respective TCP connection request. When the server attempts to place a new TCP connection request on a full embryonic queue, the host, via the TCP protocol, will remove the entry at the end of the embryonic queue. The last entry, due to the high timer value, is more likely to having performed unsuccessful attempts at completing a connection.

### BACKGROUND OF THE INVENTION

1. Technical Field

The present invention relates in general to the field of data processing systems, and specifically, the field of networked data processing systems. Still more particularly, the present invention relates to a system and method of handling connection requests between networked data processing systems.

2. Description of the Related Art

Transmission Control Protocol (TCP) is one of the most widely-used transmission protocols on the Internet. Because TCP provides a reliable and in-order byte stream between two points of communication, applications utilizing TCP do not have to keep track of data lost or re-ordered during transmission.

To establish connections utilizing TCP, the sending and receiving hosts perform a three-way handshake. First, the sending host (host A) sends a synchronize (SYN) signal to the receiving host (host B). The SYN signal indicates to host B that host A is ready to transmit. After host B receives the SYN signal from host A, host B sends a SYN/ACK message that indicates that host B acknowledges and accepts the connection. If host A receives the SYN/ACK message, host A will respond with a second ACK message, after which traffic can flow over the established TCP connection.

When a server, such as host B, receives the initial SYN message, it typically creates a new process thread to handle the client (host A) connection request. The creation and maintenance of the process thread utilizes processor and system memory resources. When the TCP session terminates, the processor and system memory resources are released and ready for allocation to other tasks.

However, the TCP connection process includes several disadvantages. For example, since servers such as host A and host B typically service multiple connections, connection requests in the form of SYN signals are usually placed on a TCP connection queue (hereinafter referred to as an “embryonic queue). All embryonic queues are finite in length, and may become saturated due to dynamic factors such as connection receipt rate, available system resources, protocol response, and application behavior. Those with skill in this art will appreciate that when an embryonic queue is full, a configuration parameter causes a randomly chosen embryonic queue entry to be deleted in order to free an entry slot for a newly arrived connection request. This random deletion is arbitrary and inefficient. Therefore, there is a need for a system and method of handling TCP connection requests that does not require random deletion of received TCP connection requests.

### SUMMARY OF THE INVENTION

The present invention mitigates the effects of embryonic queue saturation that results from, among other things, connection receipt rate, system resources (e.g., CPU dispatch), protocol response (e.g., timers), application behavior (e.g., accept of connections), and malicious SYN flood attacks utilizing spoofed valid IP addresses.

A preferred embodiment of the present invention discloses a system and method for responding to a full TCP queue. After a server receives a TCP connection request from a client, the server places the request on an embryonic queue of TCP connection requests sorted by the amount of elapsed time since the server has respond to each respective TCP connection request. When the server attempts to place a new TCP connection request on a full embryonic queue, the host, via the TCP protocol, will remove the entry at the end of the embryonic queue. The last entry, due to the high timer value, is more likely to having performed unsuccessful attempts at completing a connection.

The above-mentioned features, as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 is a block diagram illustrating an exemplary network in which a preferred embodiment of the present invention may be implemented;

FIG. 2A is a block diagram depicting an exemplary data processing system in which a preferred embodiment of the present invention may be implemented;

FIG. 2B is a block diagram illustrating an exemplary embryonic queue in which a preferred embodiment of the present invention may be implemented;

FIG. 3 is a high-level flowchart diagram depicting a TCP connection protocol according to a preferred embodiment of the present invention; and

FIG. 4 is a high-level flowchart diagram illustrating a method of responding to a full TCP queue according to a preferred embodiment of the present invention.

### DETAILED DESCRIPTION OF THE PREFERRED EMBODIMENT

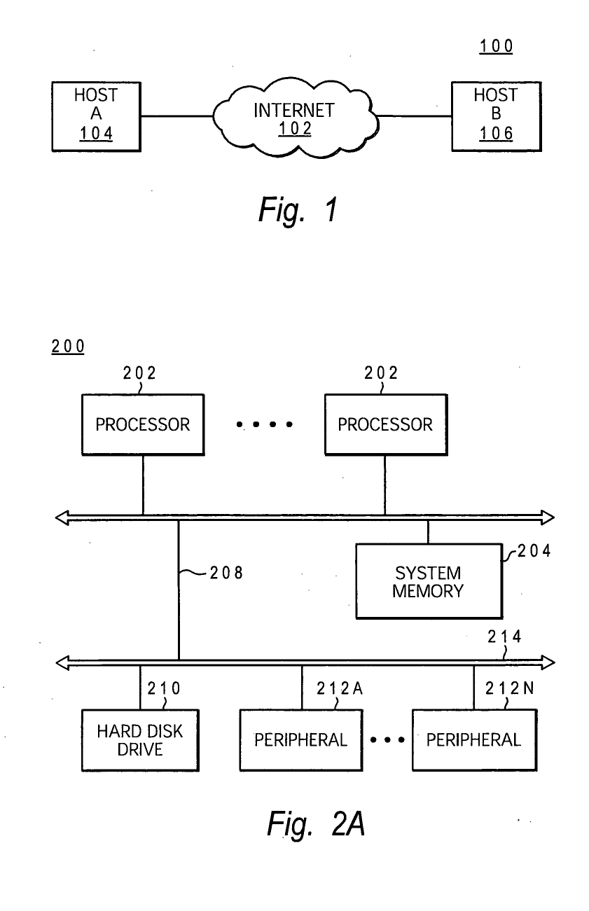

Now referring to the figures, and in particular, with reference to FIG. 1, there is depicted an exemplary network 100 in which a preferred embodiment of the present invention may be implemented. As depicted, network 100 includes Internet 102, host A (client) 104, and host B (server) 106. In a preferred embodiment of the present invention, host A 102 seeks to establish a connection with host B 106 via Internet 102.

Those skilled in the art will appreciate that network 100 can include many additional components (e.g., routers, firewalls, etc.) not specifically illustrated in FIG. 1. Because such additional components are not necessary for an understanding of the present invention, they are not illustrated in FIG. 1 or discussed further herein.

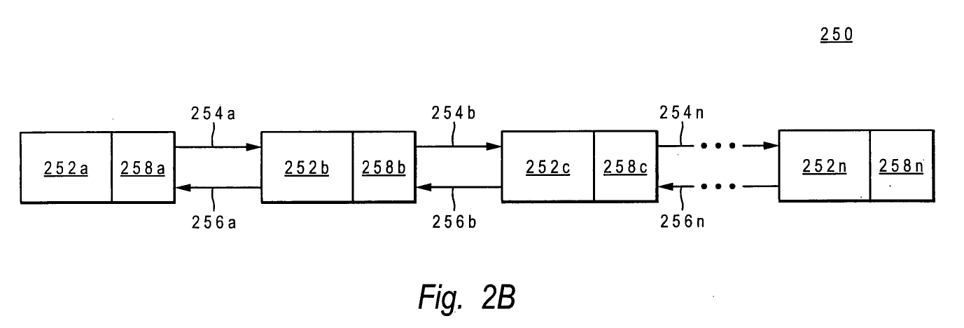

With reference now to FIG. 2A, there is depicted an exemplary data processing system 200 in which a preferred embodiment of the present invention may be implemented. As illustrated, exemplary data processing system 200 may be implemented on a general purpose computer, such as one of the members of the IBM-compatible family of computers, or one of several workstation or graphics computer devices which are presently commercially available. Host A 104 and host B 106 may be implemented as a data processing system such as data processing system 200.

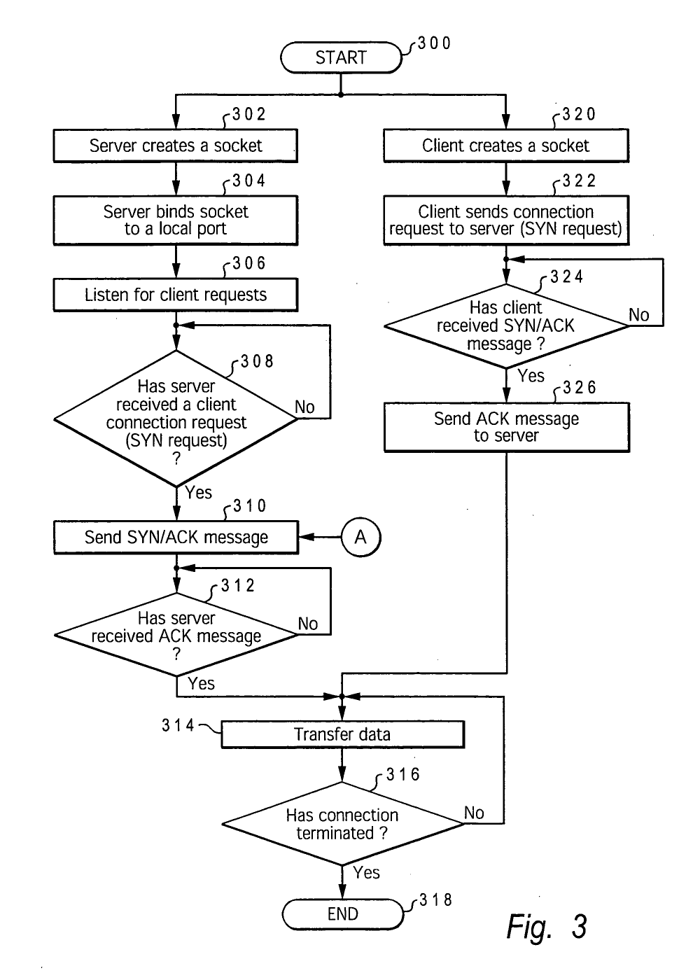

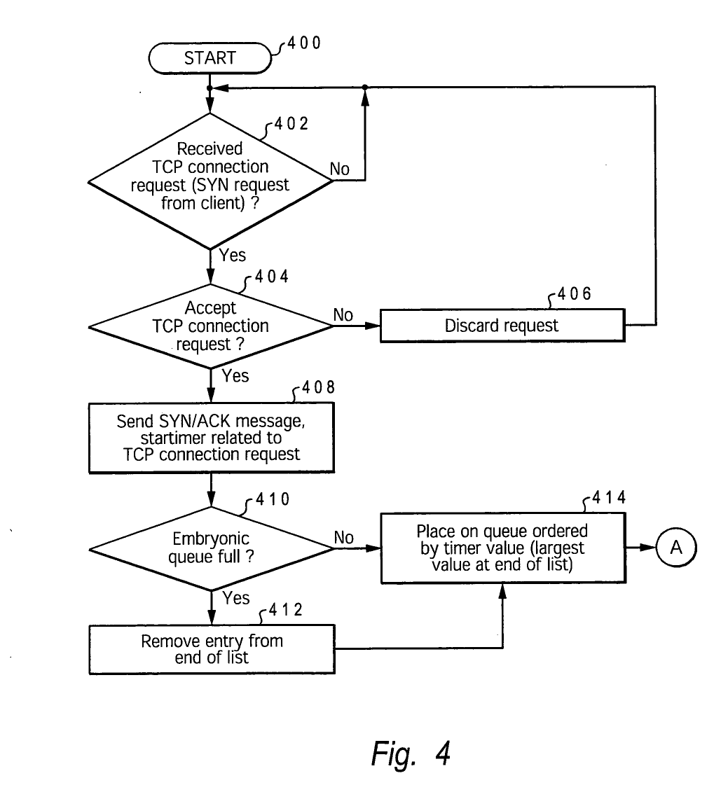

As depicted, exemplary data processing system 200 includes processor(s) 202, which are coupled to system memory 204 via system bus 206. Preferably, system memory 204 may be implemented as a collection of dynamic random access memory (DRAM) modules. Typically, system memory 204 includes data and instructions for running a collection of applications. In the present invention, system memory 204 includes a collection of sockets (not illustrated) instantiated by processor(s) 202 to enable data processing system 200 to communicate with other data processing systems on a network. Also, system memory 204 preferably includes an embryonic queue 250, as depicted in FIG. 2B, to accept and order TCP connection requests from other data processing system on the network. Embryonic queue 250 is preferably implemented as a double-linked list. A double-linked list includes a collection of nodes 252a-n with pointers 254a-n and 256a-n referencing the next and previous nodes. In the present invention, the nodes are preferably TCP connection requests from clients seeking to form a connection with data processing system 200. As discussed further in more detail in conjunction with FIGS. 3 and 4, the nodes in the double-linked list each also include a timer field 258a-n that indicates the amount of elapsed time since the host (in this case, data processing system 200) has issued a SYN/ACK message in response to the particular TCP connection request.

Now referring to back FIG. 2A, mezzanine bus 208 acts as an intermediary between system bus 206 and peripheral bus 214. Those with skill in this art will appreciate that peripheral bus 214 may be implemented as a peripheral component interconnect (PCI), accelerated graphics port (AGP), or any other peripheral bus. Coupled to peripheral bus 214 is hard disk drive 210, which is utilized by data processing system 200 as a mass storage device. Also coupled to peripheral bus 214 are a collection of peripherals 212a-n.

Those skilled in the art will appreciate that data processing system 200 can include many additional components not specifically illustrated in FIG. 2A. Because such additional components are not necessary for an understanding of the present invention, they are not illustrated in FIG. 2A or discussed further herein. It should also be understood, however, that the enhancements to data processing system 200 to improve response to a full TCP queue provided by the present invention are applicable to data processing systems of any system architecture and are in no way limited to the generalized multi-processor architecture or symmetric multi-processing (SMP) architecture illustrated in FIG. 2A.

A preferred embodiment of the present invention, network 100 of FIG. 1, includes two data processing systems 200 that operate in a client-server configuration. Those with skill in this art will appreciate that the present invention is not limited to a client-server configuration and may be implemented utilizing other network configurations including, but not limited to mainframes networks, file-sharing networks, and peer-to-peer networks.

Frequently, networks such as network 100 utilize various protocols to enable connectivity between parts of the network. While a preferred embodiment of the present invention utilizes the transmission control protocol (TCP), those with skill in this art will appreciate that the system and method disclosed in the present invention are applicable to other communications protocols such as Winsock, NetBIOS, etc.

In a preferred embodiment of the present invention, TCP operates as an extension of the operating system kernel. That is, the operating system enables TCP operations to be carried out without extra TCP programs. However, in some embodiments of the present invention, TCP operations may be handled utilizing specialized TCP programs.

FIG. 3 is a high-level flowchart diagram illustrating an exemplary client-server interaction in which a preferred embodiment of the present invention may be implemented. This exemplary client-server interaction represents a server creating a socket to listen for connection requests, fielding those requests, and transferring data between the server and the client. Also, the client creates a socket to communicate with the server, connects to the server via the socket, and transfers data between the client and the server.

As illustrated, FIG. 3 is divided into two interacting parts, one representing the actions taken by the server (blocks 302-312), and the other representing the actions taken by the client (blocks 320-326). With respect to the server, the process begins at step 300 and proceeds to step 302, which illustrates the server creating a socket to enable the server to communicate with clients. Sockets are utilized by computer systems for communication between processes either within a single computer system or across a network such as the internet.

The process then proceeds to step 304, which depicts the server binding the socket to a local port in the server. Then, the process continues to step 306, which illustrates the server listening for client requests through the local port via the socket. Then, as illustrated in step 308, the server determines whether a TCP connection request has been received from a client. If a TCP connection request has not been received by the server, the process iterates at step 308. However, if a TCP connection request has been received by the server, the process continues to step 310, which depicts the server sending a SYN/ACK request to acknowledge and accept the SYN request from the client.

Then, as depicted in step 312, the server determines whether or not an ACK message has been received from the client. If the server determines an ACK message has not been received from a client, the process iterates at step 312. However, if the server determines an ACK message has been received from a client, the process continues to step 314, which illustrates the server and client transferring data over the established connection. The process then continues to step 316, which illustrates the server determining whether or not the connection between the server and client has been terminated, either through an explicit connection termination or a connection time-out. If the connection has not been terminated, the process returns to step 314 and proceeds in an iterative fashion. If, however, the server determines that the connection has terminated, the process proceeds to step 318, which illustrates the process ending.

With respect to the client, the process begins at step 300 and proceeds to step 320, which illustrates the client creating a socket and binding that socket to a local port for communication with the server. Then, as depicted in step 322, the client sends a connection request to the server, preferably in the form of a SYN request. Then, the client determines whether it has received a SYN/ACK message from the server, as illustrated in step 324. If the client has not received a SYN/ACK message from the server, the process iterates at step 324. However, if the client has received a SYN/ACK message from the server, the process continues to step 326, which illustrates the client sending an ACK message to the server, which completes the three-way handshake procedure and enables the server and the client to form a connection. Then, the server and client begin transfer of data, as illustrated in step 314. Periodically, as previously discussed, the server and client determine whether or not the connection has been terminated, as depicted in step 316. If the connection has not been terminated, the process returns to step 314 and proceeds in an iterative fashion. If the connection has been terminated, the process continues to step 318, which depicts the process ending.

FIG. 4 is a high-level flowchart diagram illustrating in more detail steps 308 and 310 of FIG. 3. The process beings at step 400 and continues to step 402, which illustrates the server determining whether a TCP connection request (in the form of a SYN signal) has been received from a client. If a TCP connection request has not been received by the server, the process iterates at step 402. However, if a TCP connection request has been received by the server, the process continues to step 404, which depicts the server determining whether to accept the connection request. Some reasons why a server would not accept a connection request include, but are not limited to: connection requests from restricted servers and the lack of resources to service the request. If the server decides not the service the TCP connection request, the process continues to step 406, which illustrates the server discarding the TCP connection request. The process then returns to step 402 and proceeds in an iterative fashion.

Returning to step 404, if the server decides to accept the TCP connection request, the process continues to step 408, which depicts the server sending a SYN/ACK signal in response to the client's SYN signal. Also, the server starts a timer related to the TCP connection request. This timer measures the amount of time that has elapsed since the SYN/ACK signal has been sent by the server. The timer value, stored in timer field 258 in TCP connection request nodes 252 as illustrated in FIG. 2B, enables the server to order the TCP requests in a queue by the elapsed time since the SYN/ACK signal has been sent, as discussed later in more detail.

The process then proceeds to step 410, which illustrates the server determining whether the embryonic queue utilized to order TCP connection request is full. If the server determines that the queue is not full, the process continues to step 414, which depicts the server placing the TCP connection request on the queue and ordering the queue by each TCP connection request's relative timer values, stored in timer field 258. By ordering the queue, the server places the TCP connection requests will a smaller timer value at the front of the queue and the requests with a larger value at the end of the queue. A TCP connection requests with larger timer values have a lesser probability of successful connection completion. Usually, a TCP connection request that results in a successful connection has an associated timer value that is small because clients that are more likely to connect successfully promptly return the SYN/ACK signal from the server. The process then proceeds to marker A and continues to step 310 in FIG. 3.

Returning to step 410, if the server determines that the embryonic queue is full, the process continues to step 412, which illustrates the server removing an entry at the end of the list to enable the newly-received and accepted TCP connection entry to be placed on the queue. As previously discussed, TCP connection requests at the end of the embryonic queue have larger timer values and are thus more likely to not result in a successful connection. Therefore, the TCP connection requests located at the end of the queue are more logical candidates for deletion from the queue to enable a newly-received TCP connection request to be placed on the queue. The process then continues to step 414, which was discussed previously. Then, the process returns to step 402 and proceeds in an iterative fashion.

As disclosed, the present invention is a system and method of responding to a full TCP embryonic queue. After a server receives a TCP connection request from a client, the server places the request on an embryonic queue of TCP connection request sorted by the amount of elapsed time since the server has responded to the respective TCP connection request. When the server attempts to place a new TCP connection request on a full embryonic queue, the server, via the TCP protocol, will removed the entry at the end of the embryonic queue. The last entry, due to the high timer value, is more likely to having performed unsuccessful attempts at completing a connection.

Also, it should be understood that at least some aspects of the present invention may alternatively implemented in a program product. Programs defining functions on the present invention can be delivered to a data storage system or a computer system via a variety of signal-bearing media, which include, without limitation, non-writable storage media (e.g., CD-ROM), writable storage media (e.g., floppy diskette, hard disk drive, read/write CD-ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A data processing system comprising:
a processor;
an interconnect;
a system memory, coupled to said processor via said interconnect, wherein said system memory stores a connection manager, wherein in response to receiving a connection request from a client, said connection manager orders said connection request in a list by an amount of expired time since said data processing system has responded to said connection request, and said operating system removes said connection request with a largest timer value.

2. The data processing system according to claim 1, wherein said list is a double-linked list.

3. The data processing system according to claim 1, wherein said connection request is a SYN signal.

4. The data processing system according to claim 1, wherein said list is an embryonic queue.

5. A method comprising:
in response to receiving a connection request from a client, ordering said connection request in a list by a timer value which represents an amount of expired time since said data processing system has responded to said connection request; and
removing said connection request with a largest timer value.

6. The method according to claim 5, wherein said list is a double-linked list.

7. The method according to claim 5, wherein said connection request is a SYN signal.

8. The method according to claim 5, wherein said list is an embryonic queue.

9. A computer-readable medium for storing a computer program product that comprises instructions for:
in response to receiving a connection request from a client, ordering said connection request in a list by a timer value which represents an amount of expired time since said data processing system has responded to said connection request; and
removing said connection request with a largest timer value.

10. The computer-readable medium according to claim 9, wherein said list is a double-linked list.

11. The computer-readable medium according to claim 9, wherein said connection request is a SYN signal.

12. The computer-readable medium according to claim 9, wherein said list is an embryonic queue.
